(19) United States
(12) Patent Application Publication
(10) Pub. No.: US 2026/0370640 A1
(43) Pub. Date: Nov. 19, 2026

(54) METHODS AND SYSTEMS FOR OBSCURING LOGIN CREDENTIALS

(71) Applicant: Comcast Cable Communications, LLC, Philadelphia, PA (US)

(72) Inventor: Richard WIKOFF, Yardley, PA (US)

(21) Appl. No.: 19/209,395

(22) Filed: May 15, 2025

(51) Int. Cl. H04L 9/40; G06F 3/04817

(52) U.S. Cl. CPC H04L 63/083; G06F 3/04817

(57) ABSTRACT

Methods and systems for obfuscating login credentials are disclosed. An input box may be associated with receiving login credentials. Based on a first user interaction with the input box, data indicative of a first input character may be received. Output of a first symbol in the input box may be caused based on the data indicative of the first input character. The first symbol may be different than the first input character. Based on a second user interaction with the input box, data indicative of a second input character may be received. Output of a second symbol in the input box may be caused based on the data indicative of the second input character. The second symbol may be different than the second input character. The first symbol and the second symbol may belong to a set of sequentially ordered symbols.

### BACKGROUND

A user may need to enter a password in order to access an account. A longer password may be beneficial for security reasons—the longer the password, the more difficult it may be for an unauthorized user to guess the password and gain access to the account. However, users are more likely to mistype longer passwords when attempting to access their own accounts.

### SUMMARY

Systems and methods for obscuring login credentials are described herein. To access (e.g. log in to) an account, a user may enter a login credential, such as a username and/or password, into an input box. The login credential may comprise various characters (e.g., letters, numbers, symbols, etc.). As the user enters the characters into the input box, the characters may be obfuscated using a logically ordered set of symbols. The logically ordered set of symbols may comprise a plurality of symbols (e.g., letters, numbers, icons, etc.) that are arranged in a sequential order. The logical ordering of the symbols may enable the user to easily determine how many characters have already been entered into the input box, thereby improving the typing accuracy of the user and reducing the quantity of failed log-in attempts.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system.

FIG. 2A is an example input box.

FIG. 2B is an example input box.

FIG. 3A is an example input box.

FIG. 3B is an example input box.

FIG. 4 is an example method.

FIG. 5 is an example method.

FIG. 6 is an example method.

FIG. 7 is an example computing device.

### DETAILED DESCRIPTION

A user may need to enter login credentials, such as a user name and/or a password (e.g., passphrase), into an input box in order to log into an account (e.g., online account). As the user enters (e.g., types) characters into the input box, the characters may be obscured. For example, if the user enters a password into the input box, the characters that make up the password may not be displayed in the input box. Instead, a string of repeating dots or symbols (e.g., * * * * *) may be displayed in the input box. Obscuring the user-entered characters in this manner may ensure that the login credentials are kept hidden from any potential onlookers.

While obscuring the user-entered characters may enhance the security of the login credentials, such obfuscation may also make it more difficult for the user to enter the correct login credentials. For example, the user may fail to realize that he or she has mis-entered one or more of the characters in the login credentials. The user may attempt to login using the incorrect login credentials, thereby increasing the quantity of authentication failures. If the quantity of authentication failures reaches a threshold, the account may be locked, and user re-authentication may be required to unlock the account. The process of unlocking the account may cost administrative time for the system or website that maintains the account. As another example, obscuring the user-entered characters may cause the user to lose track of how many characters have been entered into the input box. If the user loses track of how many characters have been entered into the input box, the user may have to delete the already entered characters from the input box and re-start the process of entering the login credential, leading to user frustration. As such, improved techniques for obscuring login credentials are needed.

Described herein are improved techniques for obscuring login credentials. As a user enters (e.g., types) characters of a login credential into an input box, the characters may be obscured to prevent disclosure of the login credentials to any onlookers. Instead of obscuring the user-entered characters using a string of repeating dots or symbols, as is typically done, the characters may be obscured using a logically ordered set of symbols. The logically ordered set of symbols may comprise a finite set of symbols. The logically ordered set of symbols may comprise a plurality of symbols (e.g., letters, numbers, icons, etc.) that are arranged in a sequential order. For example, the logically ordered set of symbols may comprise a set of numbers in a descending order (e.g., 9, 8, 7, 6, 5, 4, 3, 2, 1) or a set of numbers in an ascending order (e.g., 1, 2, 3, 4, 5, 6, 7, 8, 9). As another example, the logically ordered set of symbols may comprise a set of letters arranged in an alphabetic sequence (e.g., A, B, C, D, E, F, G, etc.) or a set of letters arranged to form a word (e.g., P, A, S, S, W, O, R, D). As yet another example, the logically ordered set of symbols may comprise a set of colored symbols, where the symbols are arranged in a logical order based on color (e.g., red symbol, orange symbol, yellow symbol, green symbol, blue symbol, purple symbol). The logical ordering of the symbols may enable the user to easily determine how many characters have been entered into the input box, thereby reducing the quantity of authentication failures.

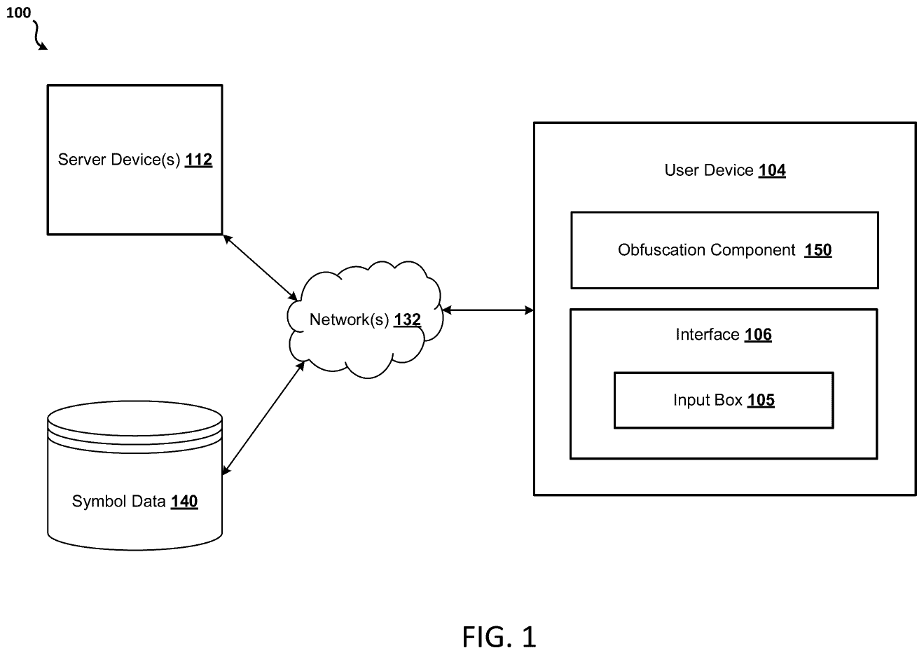

FIG. 1 is an example system 100. The system 100 may comprise at least one server device 112 and a user device 104. The user device 104 may comprise a station, a computing device, a smart device (e.g., smart glasses, smart watch, smart phone), a mobile device, a telephone, a tablet, a computing station, a laptop, a digital streaming device, a set-top box, a streaming stick, a television, and/or the like. It should be noted that while the singular terms service and device are used herein, it is contemplated that some services and devices may be implemented as a single device or a plurality of devices (e.g., via load balancing). The server device(s) 112 and the user device 104 may each be implemented as one or more computing devices. Any device disclosed herein may be implemented using one or more computing nodes, such as virtual machines, executed on a single device and/or multiple devices.

The server device(s) 112 and the user device 104 may be configured to communicate via one or more networks, such as a network 132. The network 132 may comprise any of a variety of types of networks, such as, for example, a coaxial cable network, a fiber-optic cable network, a hybrid fiber-coaxial (HFC) network, a satellite transmission channel, a DSL connection, or the like. The network 132 may comprise fiber, cable, a combination thereof. The network 132 may comprise one or more wired links, wireless links, a combination thereof, and/or the like. The network 132 may comprise one or more routers, switches, nodes, gateways, servers, modems, and/or the like. The network 132 may comprise one or more networks, such as a wide area network (e.g., the Internet), a cellular network, a Long Term Evolution (LTE) network, one or more service entity networks, a 5G network, a 6G network (and all similar and future generations/standards), and/or the like.

A user may want to access an account (e.g., an online account) via the user device 104. The account may be associated with the server device(s) 112. The user may open an application or website associated with the account via the user device 104. Based on the user opening an application or website associated with the account, the user device 104 may cause output (e.g., display) of a log-in screen via the interface 106. The log-in screen may comprise at least one input box 105 configured to receive login credentials, such as a username and/or password, from the user.

The user may input (e.g., enter, type) his or her login credentials into the input box to access the account. The login credentials may comprise a plurality of characters (e.g., letters, numbers, symbols, etc.). For example, if a password is “superman1990,” the password may comprise twelve characters: “s,” “u,” “p,” “e,” “r,” “m,” “a,” “n,” “1,” “9,” “9”, and “0.” The user may input the plurality of characters one at a time. As the user enters the plurality of characters, the user device 104 may obscure the plurality of characters using a set of logically ordered symbols.

For example, the user device 104 may receive data indicative of a first input character (e.g., “s”) based on a first user interaction with the input box 105. Based on (e.g., in response to) receiving the data indicative of the first input character (e.g., “s”), an obfuscation component 150 of the user device 104 may determine a first symbol among a set of logically ordered symbols. The first symbol may be different from the first input character (e.g., “s”). The first symbol may coincidentally be the same as the first input character (e.g., if the first input character happens to be the same as the first symbol among the set of logically ordered symbols). To determine the first symbol among the set of logically ordered symbols, the obfuscation component 150 may retrieve and/or analyze symbol data 140. The symbol data 140 may be stored locally on the user device 104 and/or may be stored on a database located external to the user device 104.

The symbol data 140 may indicate one or more logically ordered set of symbols. A logically ordered set of symbols may comprise a set of numbers (e.g., a finite set of numbers) in a descending order (e.g., 9, 8, 7, 6, 5, 4, 3, 2, 1) or a set of numbers in an ascending order (e.g., 1, 2, 3, 4, 5, 6, 7, 8, 9). As another example, a logically ordered set of symbols may comprise a set of letters (e.g., a finite set of letters) arranged in an alphabetic sequence (e.g., A, B, C, D, E, F, G, etc.) or a set of letters arranged to form a word (e.g., P, A, S, S, W, O, R, D). As yet another example, a logically ordered set of symbols may comprise a set of colored symbols (e.g., a finite set of colored symbols), where the symbols are arranged in a logical order based on color (e.g., red symbol, orange symbol, yellow symbol, green symbol, blue symbol, purple symbol).

The obfuscation component 150 may cause output of the first symbol in the input box 105 to obscure the first input character (e.g., “s”). Causing output of the first symbol in the input box 105 to obscure the first input character may comprise causing output of the first symbol instead of the first input character (e.g., “s”) in the input box 105. The user device 104 may cause temporary output of the first input character (e.g., “s”) in the input box 105 before the obfuscation component 150 replaces the first input character with the first symbol. Alternatively, the user device 104 may not cause any output of the first input character in the input box 105 (e.g., “s” may never be displayed in the input box 105).

As the user continues to input the login credential, the user device 104 may receive data indicative of a second input character (e.g., “u”) based on a second user interaction with the input box 105. Based on (e.g., in response to) receiving the data indicative of the second input character (e.g., “s”), an obfuscation component 150 of the user device 104 may determine a second symbol among the set of logically ordered symbols. The second symbol may be different from the second input character (e.g., “u”). The second symbol may coincidentally be the same as the second input character (e.g., if the second first input character happens to be the same as the second symbol among the set of logically ordered symbols). The second symbol may be different from the first symbol. The second symbol may immediately follow the first symbol in the set of logically ordered symbols. For example, if the set of logically ordered symbols comprises a set of numbers in an ascending order (e.g., 1, 2, 3, 4, 5, 6, 7, 8, 9), the first symbol may be “1” and the second symbol may be “2.” To determine the second symbol among the set of logically ordered symbols, the obfuscation component 150 may retrieve and/or analyze the symbol data 140.

The obfuscation component 150 may cause output of the second symbol, along with the first symbol, in the input box 105 to obscure the second input character (e.g., “u”). Causing output of the second symbol in the input box 105 to obscure the second input character may comprise causing output of the second symbol instead of the second input character (e.g., “u”) in the input box 105. The user device 104 may cause temporary output of the second input character (e.g., “u”) in the input box 105 before the obfuscation component 150 replaces the second input character with the second symbol. Alternatively, the user device 104 may not cause any output of the second input character in the input box 105 (e.g., “u” may never be displayed in the input box 105).

The obfuscation component 150 may continue this process of obscuring the characters input by the user until the user has finished entering the login credentials. If the login credential comprises a greater quantity of characters than there are symbols in the set of logically ordered symbols (e.g., finite set of logically ordered symbols), the obfuscation component 150 may begin to repeat the set of logically ordered symbols. For example, a password (e.g., “superman1990”) may comprise twelve characters, while the set of logically ordered symbols may comprise only nine symbols (e.g., 1, 2, 3, 4, 5, 6, 7, 8, 9). As such, instead of displaying the password in the input box 105, the obfuscation component 150 may cause display of “1, 2, 3, 4, 5, 6, 7, 8, 9, 1, 2, 3, 4” in the input box 105.

By obscuring the user-input characters using a set of symbols arranged in a logical order, the user can easily determine how many characters the user has entered into the input box 105, thereby improving the typing accuracy for login credentials and reducing the quantity of authentication failures. Over time, users, especially frequent users, can learn how the obscured login credential should appear in the input box 105. For example, if the user's password is “superman”, the user may learn that the numbers “1,” “2” “3,” “4,” “5,” “6,” “7,” and “8” should appear in the input box 105, because “superman” comprises eight characters. If the user knows that the numbers “1,” “2” “3,” “4,” “5,” “6,” “7,” and “8” should appear in the input box 105, but the user only sees “the numbers “1,” “2” “3,” “4,” “5,” “6,” and “7” in the input box 105, this may indicate to the user that the user has mis-entered the password, or that the user has not finished entering the password.

While the user device 104 may obscure the characters input by the user using the set of logically ordered symbols, it should be appreciated that the server device(s) 112 may additionally, or alternatively, be configured to obscure the characters input by the user using the set of logically ordered symbols. For example, based on (e.g., in response to) the user device 104 receiving the data indicative of the first input character, the user device 104 may send the data indicative of the first input character to the server device(s) 112. The server device(s) 112 may determine the first symbol among the set of logically ordered symbols (e.g., using the symbol data 140). The server device(s) 112 may send data indicating the first symbol back to the user device 104. The user device 104 may receive the data indicating the first symbol. Based on (e.g., in response to) receiving the data indicating the first symbol, the user device 104 (e.g., the obfuscation component 150) may cause output of the first symbol in the input box 105 to obscure the first input character.

Likewise, based on (e.g., in response to) the user device 104 receiving the data indicative of the second input character, the user device 104 may send the data indicative of the second input character to the server device(s) 112. The server device(s) 112 may determine the second symbol among the set of logically ordered symbols (e.g., using the symbol data 140). The server device(s) 112 may send data indicating the second symbol back to the user device 104. The user device 104 may receive the data indicating the second symbol. Based on (e.g., in response to) receiving the data indicating the second symbol, the user device 104 (e.g., the obfuscation component 150) may cause output of the second symbol in the input box 105 to obscure the second input character. The user device 104 and the server device(s) 112 may continue this process of obscuring the characters input by the user until the user has finished entering the login credentials.

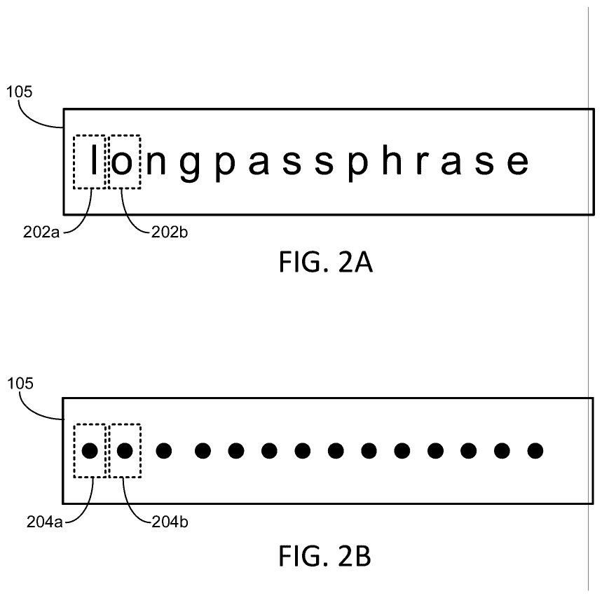

FIG. 2A is an example input box 105. The user may input (e.g., enter, type) his or her login credentials into the input box to access the account. The login credentials may comprise a plurality of characters (e.g., letters, numbers, symbols, etc.). For example, if a password is “longpassphrase,” the password may comprise fourteen characters: “l,” “o,” “n,” “g,” “p,” “a,” “s,” “s,” “p,” “h,” “r”, “a”, “s”, and “e.” The first input character 202a may be the character “l,” while the second input character 202b is the character “o,” and so on. Though all fourteen characters input by the user are shown as being output in the input box 105 in FIG. 2A, it should be appreciated that the characters may not actually be visible to the user. For example, the characters may be obfuscated as shown in FIG. 2B, where each of the fourteen characters is represented by a symbol (e.g., the dot) in a string of repeating symbols. For example, the dot 204a may be output instead of the first input character 202a, the dot 204b may be output instead of the second input character 202b, and so on. Obscuring the user-entered characters in this manner may ensure that the login credentials are kept hidden from any potential onlookers.

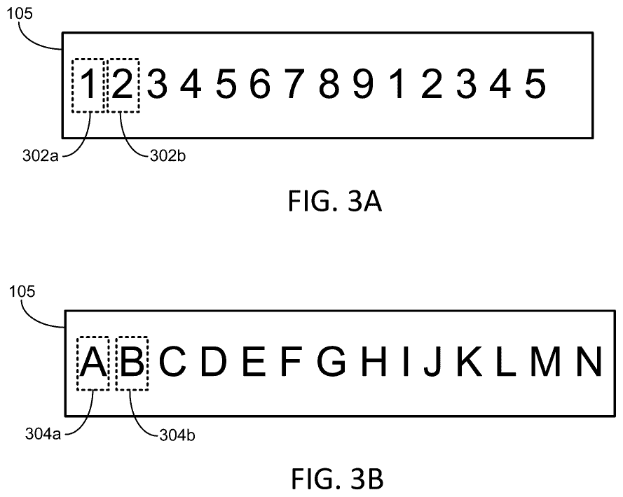

While obscuring the user-entered characters using the string of repeating symbols (e.g., dots 204a-b) may enhance the security of the login credentials, such obfuscation may also make it more difficult for the user to enter the correct login credentials. For example, the user may fail to realize that he or she has mis-entered one or more of the characters in the login credentials and/or the user may lose track of how many characters have been entered into the input box 105. Instead of obscuring the user-entered characters using a string of repeating dots or symbols, the characters may be obscured using a logically ordered set of symbols, as shown in FIGS. 3A-B.

FIG. 3A shows the fourteen characters of the password “longpassphrase” being obfuscated using a set of numbers arranged in an ascending order (e.g., 1, 2, 3, 4, 5, 6, 7, 8, 9). For example, the symbol 302 a (“1”) may be output instead of the first input character 202a, the symbol 302b (“2”) may be output instead of the second input character 202b, and so on. Similarly, FIG. 3B shows the fourteen characters of the password “longpassphrase” being obfuscated using a set of letters arranged in alphabetical order (e.g., A, B, C, D, E, etc). For example, the symbol 304a (“A”) may be output instead of the first input character 202a, the symbol 304b (“B”) may be output instead of the second input character 202b, and so on.

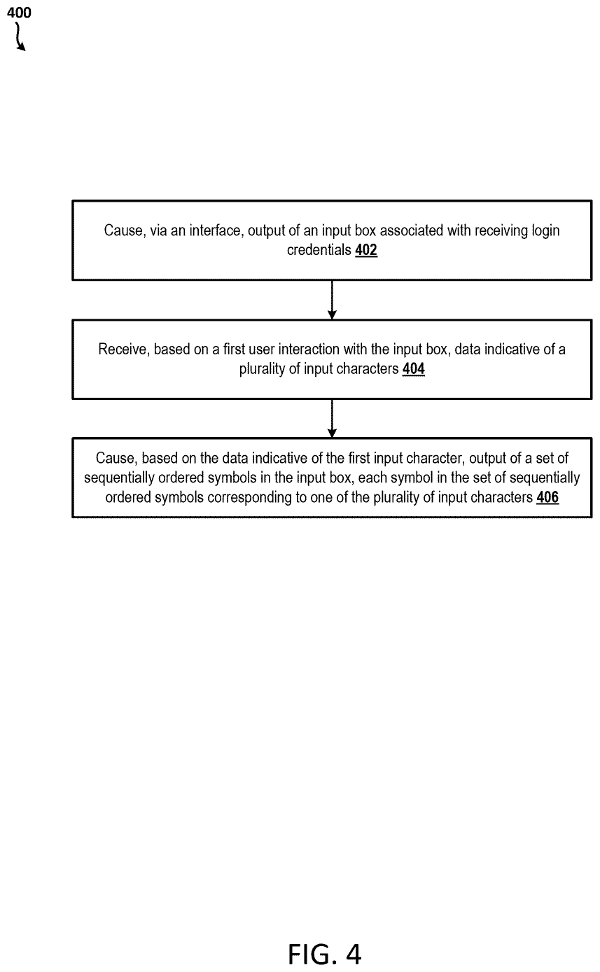

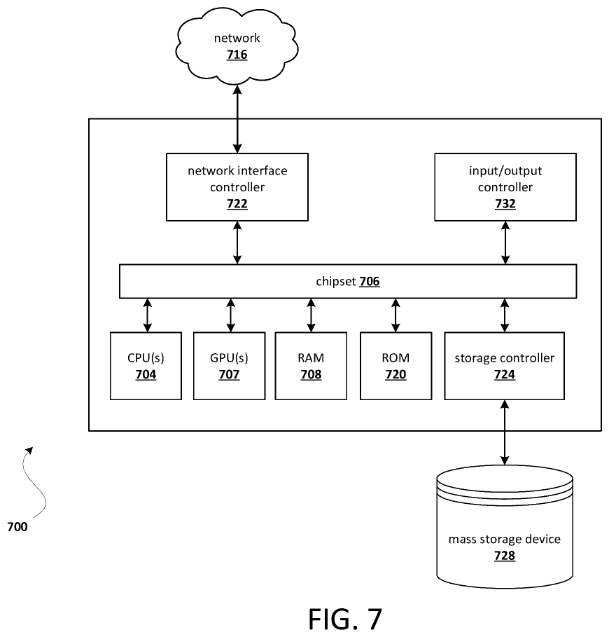

FIG. 4 is an example method 400. The method 400 may comprise a computer implemented method for obscuring login credentials. A system and/or computing environment, such as the system 100 of FIG. 1 and/or the computing environment of FIG. 7, may be configured to perform the method 400. For example, the user device 104 and/or the server device(s) 112 of FIG. 1 may be configured to perform the method 400.

At 402, output of an input box may be caused. The output may be caused via an interface of a user device. The output box may be associated with receiving login credentials (e.g., a username and/or password). A user may input (e.g., enter, type) his or her login credentials into the input box to access an account. The login credentials may comprise a plurality of characters (e.g., letters, numbers, symbols, etc.). The user may input the plurality of characters one at a time. As the user inputs the plurality of characters, the plurality of characters may be obscured using a set of sequentially ordered symbols. At 404, data indicative of the plurality of input characters may be received. The data indicative of the plurality of input characters may be received based on (e.g., in response to) one or more user interactions with the input box.

At 406, output of a plurality of symbols may be caused. The plurality of symbols may comprise a set of sequentially ordered symbols. The set of sequentially ordered symbols may comprise a set of numbers in a descending order or an ascending order. The set of sequentially ordered symbols may comprise a set of letters arranged in an alphabetic sequence. The set of sequentially ordered symbols may comprise a set of icons arranged in a color-based sequence. The set of sequentially ordered symbols may comprise a repeating finite set of sequentially ordered symbols. Output of the plurality of symbols may be caused based on the data indicative of the plurality of input characters. The plurality of symbols may be output in the input box. For example, the plurality of symbols may be output in the input box instead of the plurality of input characters (e.g., the plurality of input characters may not be visible to the user). Each symbol in the plurality of symbols may correspond to one of the plurality of input characters. At least one symbol in the plurality of symbols may be different than the corresponding input character of the plurality of input characters. At least one other symbol in the plurality of symbols may coincidentally be the same as the corresponding input character of the plurality of input characters. (e.g., if the corresponding input character happens to be the same as the symbol among the set of sequentially ordered symbols).

This process of obscuring the characters input by the user may be repeated until the user has finished entering the login credentials. By obscuring the user-input characters using the set of sequentially ordered symbols, the user can easily determine how many characters the user has entered into the input box, thereby improving the typing accuracy for login credentials and reducing the quantity of authentication failures.

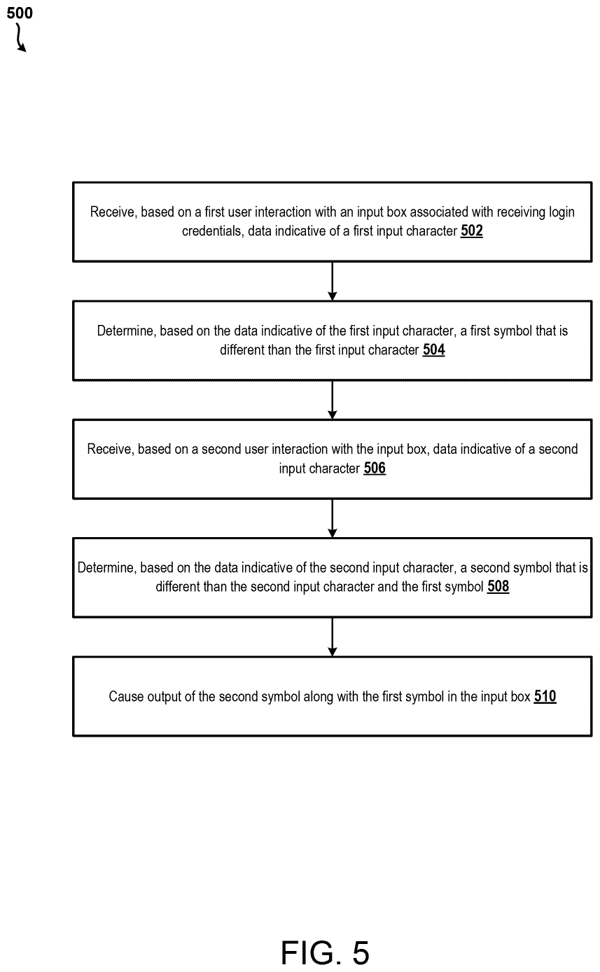

FIG. 5 is an example method 500. The method 500 may comprise a computer implemented method for obscuring login credentials. A system and/or computing environment, such as the system 100 of FIG. 1 and/or the computing environment of FIG. 7, may be configured to perform the method 500. For example, the user device 104 and/or the server device(s) 112 of FIG. 1 may be configured to perform the method 500.

A user may input (e.g., enter, type) his or her login credentials (e.g., a username and/or password) into an input box to access an account. The login credentials may comprise a plurality of characters (e.g., letters, numbers, symbols, etc.). The user may input the plurality of characters one at a time. As the user inputs the plurality of characters, the plurality of characters may be obscured using a set of symbols.

At 502, data indicative of a first input character may be received. The first input character may comprise a first character among the plurality of characters. The data indicative of the first input character may be received based on (e.g., in response to) a first user interaction with the input box. At 504, a first symbol may be determined. The first symbol may be different than the first input character. The first symbol may coincidentally be the same as the first input character (e.g., if the first input character happens to be the same as the first symbol among a set of sequentially ordered symbols). The first symbol may be determined based on the data indicative of the first input character. To determine the first symbol, symbol data indicating a set of symbols (e.g., sequentially ordered symbols) may be retrieved and/or analyzed. The first symbol may be output in the input box.

At 506, data indicative of a second input character may be received. The second input character may comprise a second character among the plurality of characters. The data indicative of the second input character may be received based on (e.g., in response to) a second user interaction with the input box. At 508, a second symbol may be determined. The second symbol may be different than the second input character. The second symbol may coincidentally be the same as the second input character (e.g., if the second input character happens to be the same as the second symbol among the set of sequentially ordered symbols). The second symbol may be determined based on the data indicative of the second input character. To determine the second symbol, the symbol data indicating the set of symbols may be retrieved and/or analyzed. The second symbol may be different than the first symbol. The second symbol may immediately follow the first symbol in the set of symbols. For example, if the set of symbols comprises a set of numbers in an ascending order (e.g., 1, 2, 3, 4, 5, 6, 7, 8, 9), the first symbol may be “1” and the second symbol may be “2.”

At 510, output of the second symbol may be caused. The second symbol may be output in the input box. For example, the second symbol may be output in the input box instead of the second input character (e.g., the second input character may not be visible to the user). The second symbol may be output in the input box along with the first symbol. This process of obscuring the characters input by the user may be repeated until the user has finished entering the login credentials. By obscuring the user-input characters using the set of symbols, the user can easily determine how many characters the user has entered into the input box, thereby improving the typing accuracy for login credentials and reducing the quantity of authentication failures.

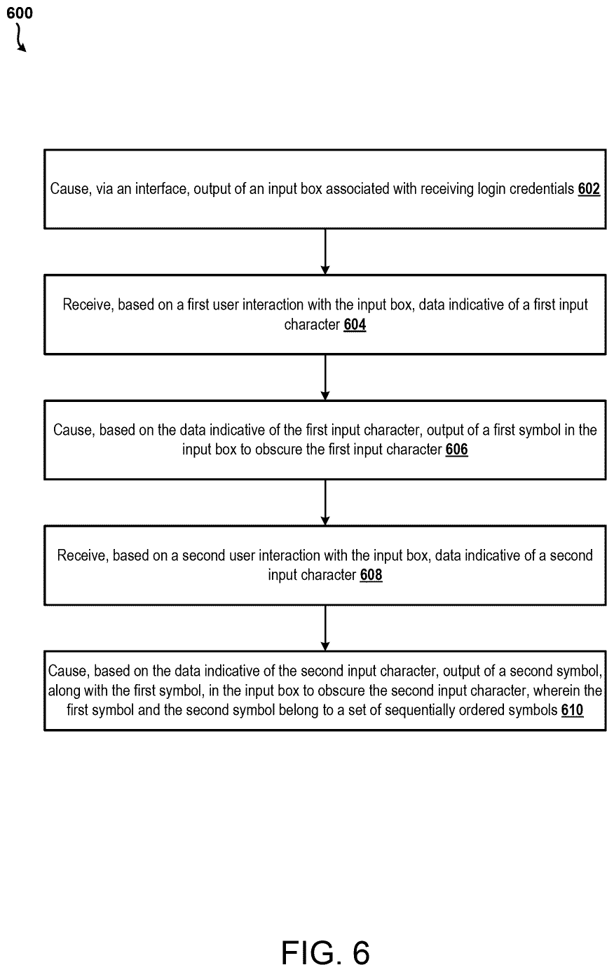

FIG. 6 is an example method 600. The method 600 may comprise a computer implemented method for obscuring login credentials. A system and/or computing environment, such as the system 100 of FIG. 1 and/or the computing environment of FIG. 7, may be configured to perform the method 600. For example, the user device 104 and/or the server device(s) 112 of FIG. 1 may be configured to perform the method 600.

At 602, output of an input box may be caused. The output may be caused via an interface of a user device. The output box may be associated with receiving login credentials (e.g., a username and/or password). A user may input (e.g., enter, type) his or her login credentials into the input box to access an account. The login credentials may comprise a plurality of characters (e.g., letters, numbers, symbols, etc.). The user may input the plurality of characters one at a time. As the user inputs the plurality of characters, the plurality of characters may be obscured using a set of sequentially ordered symbols.

At 604, data indicative of a first input character may be received. The first input character may comprise a first character among the plurality of characters. The data indicative of the first input character may be received based on (e.g., in response to) a first user interaction with the input box. At 606, output of a first symbol may be caused. Output of the first symbol may be caused based on the data indicative of the first input character. The first symbol may be output in the input box to obscure the first input character. For example, the first symbol may be output in the input box instead of the first input character (e.g., the first input character may not be visible to the user). The first symbol may be different from the first input character. The first symbol may comprise a first symbol in a set of sequentially ordered symbols. The first symbol may coincidentally be the same as the first input character (e.g., if the first input character happens to be the same as the first symbol among the set of sequentially ordered symbols).

At 608, data indicative of a second input character may be received. The second input character may comprise a second character among the plurality of characters. The data indicative of the second input character may be received based on (e.g., in response to) a second user interaction with the input box. At 610, output of a second symbol may be caused. Output of the second symbol may be caused based on the data indicative of the second input character. The second symbol may be output in the input box to obscure the second input character. For example, the second symbol may be output in the input box instead of the second input character (e.g., the second input character may not be visible to the user). The second symbol may be different from the first input character. The second symbol may be different than the first symbol. The second symbol may comprise a second symbol in the set of sequentially ordered symbols. The second symbol may coincidentally be the same as the second input character (e.g., if the second input character happens to be the same as the second symbol among the set of sequentially ordered symbols). The second symbol may immediately follow the first symbol in the set of sequentially ordered symbols. For example, if the set of sequentially ordered symbols comprises a set of numbers in an ascending order (e.g., 1, 2, 3, 4, 5, 6, 7, 8, 9), the first symbol may be “1” and the second symbol may be “2.”

FIG. 7 is example computing device 700 that may represent any of the various devices or entities shown in FIG. 1, including, for example, the user device 104, the server device(s) 112, and/or the obfuscation component 150. That is, the computing device 700 shown in FIG. 7 may be any smartphone, server computer, workstation, access point, router, gateway, tablet computer, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 4-6.

The computing device 700 may include a baseboard, or “motherboard,” which is a printed circuit board to which a multitude of components or devices may be connected by way of a system bus or other electrical communication paths. One or more central processing units (CPUs or “processors”) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random-access memory (RAM) 708 used as the main memory in the computing device 700. The chipset 706 may provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722. A NIC 722 may be capable of connecting the computing device 700 to other computing nodes over the network 716. It should be appreciated that multiple NICs 722 may be present in the computing device 700, connecting the computing device to other types of networks and remote computer systems. The NIC may be configured to implement a wired local area network technology, such as IEEE 802.3 (“Ethernet”) or the like. The NIC 722 may also comprise any suitable wireless network interface controller capable of wirelessly connecting and communicating with other devices or computing nodes on the system 100. For example, the NIC 722 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 700 may operate in a cellular network, a Long Term Evolution (LTE) network, one or more service entity networks, a 5G network, a 6G network (and all similar and future generations/standards), and/or the like.

The computing device 700 may be connected to a mass storage device 727 that provides non-volatile storage (i.e., memory) for the computer. The mass storage device 727 may store system programs, application programs, other program modules, and data, which have been described in greater detail herein. The mass storage device 727 may be connected to the computing device 700 through a storage controller 724 connected to the chipset 706. The mass storage device 727 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 727 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 727 is characterized as primary or secondary storage and the like.

For example, the computing device 700 may store information to the mass storage device 727 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may read information from the mass storage device 727 by detecting the physical states or characteristics of one or more particular locations within the physical storage units.

In addition to the mass storage device 727 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 727 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 727 may store other system or application programs and data utilized by the computing device 700.

The mass storage device 727 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 4-6.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
causing, via an interface of a user device, output of an input box associated with receiving login credentials;
receiving, based on at least one user interaction with the input box, data indicative of a plurality of input characters; and
causing, based on the data indicative of the plurality of input characters, output of a set of sequentially ordered symbols in the input box, wherein each symbol in the set of sequentially ordered symbols corresponds to one of the plurality of input characters, and wherein at least one symbol in the set of sequentially ordered symbols is different than the corresponding input character of the plurality of input characters.

2. The method of claim 1, wherein the set of sequentially ordered symbols comprises a set of numbers in a descending order or an ascending order.

3. The method of claim 1, wherein the set of sequentially ordered symbols comprises a set of letters arranged in an alphabetic sequence.

4. The method of claim 1, wherein the set of sequentially ordered symbols comprises a set of icons arranged in a color-based sequence.

5. The method of claim 1, wherein the set of sequentially ordered symbols comprises a repeating finite set of sequentially ordered symbols.

6. The method of claim 1, wherein the login credentials comprises at least one of a user name or a password.

7. The method of claim 1, wherein the user device comprises one or more of a set-top box, a television, a display device, a computer, a laptop, a mobile device, a smart phone, a tablet computer, a portable gaming device, or a wearable computing device.

8. A method comprising:
receiving, based on a first user interaction with an input box associated with receiving login credentials, data indicative of a first input character;
determining, based on the data indicative of the first input character, a first symbol that is different than the first input character;
receiving, based on a second user interaction with the input box, data indicative of a second input character;
determining, based on the data indicative of the second input character, a second symbol that is different than the second input character and the first symbol; and
causing output of the second symbol along with the first symbol in the input box.

9. The method of claim 8, wherein the second symbol follows the first symbol in a set of sequentially ordered symbols.

10. The method of claim 9, wherein the set of sequentially ordered symbols comprises at least one of: a set of numbers in a descending order or an ascending order, a set of letters arranged in an alphabetic sequence, a set of icons arranged in a color-based sequence.

11. The method of claim 9, wherein the set of sequentially ordered symbols comprises a repeating finite set of sequentially ordered symbols.

12. The method of claim 9, wherein the second symbol immediately follows the first symbol in the set of sequentially ordered symbols.

13. The method of claim 8, wherein the login credentials comprises at least one of a user name or a password.

14. A method comprising:
causing, via an interface of a user device, output of an input box associated with receiving login credentials;
receiving, based on a first user interaction with the input box, data indicative of a first input character;
causing, based on the data indicative of the first input character, output of a first symbol in the input box to obscure the first input character;
receiving, based on a second user interaction with the input box, data indicative of a second input character; and
causing, based on the data indicative of the second input character, output of a second symbol, along with the first symbol, in the input box to obscure the second input character, wherein the first symbol and the second symbol belong to a set of sequentially ordered symbols.

15. The method of claim 14, wherein the first symbol is different from the second symbol.

16. The method of claim 14, wherein the set of sequentially ordered symbols comprises at least one of: a set of numbers in a descending order or an ascending order, a set of letters arranged in an alphabetic sequence, a set of icons arranged in a color-based sequence.

17. The method of claim 14, wherein the set of sequentially ordered symbols comprises a repeating finite set of sequentially ordered symbols.

18. The method of claim 14, wherein the login credentials comprises at least one of a user name or a password.

19. The method of claim 14, wherein the second symbol immediately follows the first symbol in the set of sequentially ordered symbols.

20. The method of claim 14, wherein the user device comprises one or more of a set-top box, a television, a display device, a computer, a laptop, a mobile device, a smart phone, a tablet computer, a portable gaming device, or a wearable computing device.
